(19) United States
(12) Patent Application Publication
(10) Pub. No.: US 2025/0178086 A1
(43) Pub. Date: Jun. 5, 2025

(54) ULTRATHIN DEVICE, MANUFACTURING METHOD THEREFOR AND USE THEREOF

(71) Applicant: AAC Kaitai Technologies (Ma'anshan) Co., Ltd., Ma'anshan (CN)

(72) Inventors: Jinhui Yu, Ma'anshan (CN); Zhongyou Wu, Ma'anshan (CN); Quan Xie, Ma'anshan (CN); Ben Li, Ma'anshan (CN)

(21) Appl. No.: 18/733,896

(22) Filed: Jun. 5, 2024

Related U.S. Application Data
(63) Continuation of application No. PCT/CN2023/135484, filed on Nov. 30, 2023.

(51) Int. Cl. B22F 5/00; B22F 1/065; B22F 1/107; B22F 3/16; B22F 9/02

(52) U.S. Cl. CPC B22F 5/006; B22F 1/065; B22F 1/107; B22F 3/16; B22F 9/026; B22F 2201/20; B22F 2304/054

(57) ABSTRACT

An ultrathin device, manufacturing method therefor and use thereof. The method includes: granulating a mixture containing raw material powder, an adhesive and a solvent into particles by spray drying to obtain first precursor, the raw material powder including metal material powder and/or ceramic material powder, a surface mean diameter of the raw material powder ranging from 1 μm to 15 μm, a mass ratio of the raw material powder to the adhesive ranging from 100:1 to 100:10, a surface mean diameter of the first precursor ranging from 40 μm to 80 μm, and flowability of the first precursor being lower than 30 s/50 g; performing shaping process on the first precursor to obtain second precursor having a preset shape; and performing heat treatment on the second precursor to obtain the ultrathin device with a thickness smaller than or equal to 1 mm. The thickness is reduced without having a significant impact on the mechanical properties.

### TECHNICAL FIELD

The present disclosure relates to the technical field of powder metallurgy, and in particular, to an ultrathin device, a manufacturing method therefor and a use thereof.

### BACKGROUND

For a device with a specific shape, the device is usually formed by stamping, which applies an external force to a plate, a strip, a pipe, a profile and the like by means of a press and a mold, causing plastic deformation or separation to obtain a workpiece having a desired shape and size. Shaping by stamping has high productivity and simple operation, thereby being suitable for large-scale production, and has high dimensional accuracy.

For an ultrathin device having a small thickness, especially for a thickness less than 1 mm, the stamping method is limited to a certain extent, mainly in that the formation of an ultrathin device by stamping is limited by the type of materials, and it is mainly applicable to materials such as low-carbon steel and stainless steel, and is generally based on materials with carbon content <0.25% and tensile strength less than 650 N/mm². However, some materials with low ductility and high hardness are not suitable for stamping process, and the stamping process also has a certain limitation on the shape of the ultrathin device, causing a low degree of freedom in terms of forming the ultrathin device, which cannot meet the requirements.

### Technical Problem

Some materials with low ductility and high hardness are not suitable for stamping process, and the stamping process also has a certain limitation on the shape of the ultrathin device, causing a low degree of freedom in terms of forming the ultrathin device, which cannot meet the requirements.

### SUMMARY

### Technical Solution

In view of this, the present disclosure provides an ultrathin device, a manufacturing method therefor and a use thereof. The manufacturing method of the present disclosure can form an ultrathin device with a small thickness and a high degree of freedom in shape, which can fill the blank of the powder metallurgy process in the application field of ultrathin devices, thereby meeting the requirements of miniaturization and lightness of device product.

In a first aspect, an embodiment of this disclosure provides a manufacturing method for an ultrathin device, including: granulating a mixture containing raw material powder, an adhesive and a solvent into particles by spray drying, to obtain a first precursor, the raw material powder including metal material powder and/or ceramic material powder, a surface mean diameter of the raw material powder being within a range from 1 μm to 15 μm, a mass ratio of the raw material powder to the adhesive being within a range from 100:1 to 100:10, a surface mean diameter of the first precursor being within a range from 40 μm to 80 μm, and flowability of the first precursor being less than 30 s/50 g; performing shaping process on the first precursor to obtain a second precursor having a preset shape; and performing heat treatment on the second precursor to obtain the ultrathin device, a thickness of the ultrathin device is less than or equal to 1 mm.

In some embodiments, a metal material in the metal material powder includes at least one of elemental metal or alloy.

In some embodiments, the elemental metal includes at least one of iron, cobalt, nickel, chromium, or manganese.

In some embodiments, the alloy includes at least one of iron alloy, copper alloy, nickel alloy, cobalt alloy, aluminum alloy, or titanium alloy.

In some embodiments, the ceramic material powder includes at least one of aluminum oxide powder, silicon oxide powder, zirconium oxide powder, silicon carbide powder, aluminum nitride powder, or silicon nitride powder.

In some embodiments, a particle diameter of the raw material powder satisfies: D90/D10≤7.

In some embodiments, the adhesive includes a thermoplastic adhesive, and the adhesive includes at least one of polyvinyl alcohol, polyvinylpyrrolidone, or polyethylene glycol.

In some embodiments, the solvent includes at least one of water or ethanol.

In some embodiments, sphericity of the first precursor is greater than or equal to 0.7.

In some embodiments, an inlet air temperature of the spray drying is within a range from 50° C. to 300° C., and an outlet air temperature of the spray drying is within a range from 90° C. to 200° C.

In some embodiments, a device for spray drying includes at least one of a spray dryer, a centrifugal spray dryer or a multi-nozzle spray dryer.

In some embodiments, performing shaping process on the first precursor includes: placing the first precursor in a shaping mold with a preset shape for pressure treatment.

In some embodiments, a device for the pressure treatment includes a servo press with a displacement precision ranging from 1 μm to 3 μm.

In some embodiments, a pressure of the pressure treatment is within a range from 300 MPa to 1200 MPa, and a time duration of the pressure treatment is within a range from 2 s to 20 s.

In some embodiments, a material of the shaping mold includes steel, which includes at least one of ASP23, ASP60, tungsten steel, SKD11, Cr12MoV, or DC53.

In some embodiments, the heat treatment has a temperature within a range from 1100° C. to 1500° C.; the heat treatment has a time duration within a range from 0.5 h to 5 h; the heat treatment has a heating rate within a range from 1° C./min to 15° C./min; and the heat treatment is performed under a vacuum condition, and a vacuum degree of the vacuum condition is less than or equal to 10-2 Pa.

In a second aspect, an embodiment of this disclosure provides an ultrathin device formed by the manufacturing method as described in the first aspect, and a thickness of the ultrathin device is less than or equal to 1 mm.

In a second aspect, an embodiment of this disclosure provides a use of the ultrathin device formed by the manufacturing method as described in the first aspect or the ultrathin device as described in the second aspect in forming a motor, an engine, a loudspeaker, a receiver, a speaker, a microphone, a miniature vibration motor and an earphone.

### Beneficial Effect

In the present disclosure, a mixture containing the raw material powder, the adhesive and the solvent is granulated into particles by spray drying before the shaping process, and the raw material powder has a surface mean diameter ranging from 1 μm to 15 μm. In an aspect, good flowability of the material can be achieved; and in another aspect, the raw material powder has a small surface mean diameter, which is beneficial to increasing the density of the material when being mixed to form particles with an adhesive with a specific quality, to obtain a material having a small size. Compared with a conventional method in which the raw material powder is directly shaped, the first precursor according to the embodiments of the present disclosure has excellent flowability, which is lower than 30 s/50 g, making it beneficial for subsequent shaping processes, improving the flowability of the material in the shaping process, thereby improving the density and strength of ultrathin devices after the shaping process. Moreover, the first precursor with the surface mean diameter of 40 μm to 80 μm in this disclosure has a small particle diameter, which is conducive to improving the surface activity of the raw material powder. The powder in the particle-formed material is tightly combined and has a good compacted density. Then, the shaping process and heat treatment can improve the shaping performance of the shaping process and the sintering performance of the heat treatment, reduce the sintering temperature, and improve the density and the strength of the sintered ultrathin device. The first precursor before the shaping process according to the embodiments of the present disclosure has good flowability and small particle diameter. In the forming process, the thickness of the ultrathin device can be reduced without having a significant impact on the mechanical properties such as strength, rigidity, and toughness of the ultrathin device, thereby being conducive to improving the accuracy and miniaturization of the ultrathin device.

### BRIEF DESCRIPTION OF DRAWINGS

In order to better illustrate technical solutions in embodiments of the present disclosure or in the related art, the accompanying drawings used in the embodiments and in the related art are briefly introduced as follows. It should be noted that the drawings described as follows are merely part of the embodiments of the present disclosure, and other drawings can also be acquired by those skilled in the art without paying creative efforts.

FIG. 1 is a flowchart of a manufacturing method of an ultrathin device according to an embodiment of the disclosure;

FIG. 2 is a schematic structural diagram of a product of Embodiment I according to the embodiment of the disclosure;

FIG. 3 is a product size measurement result of Embodiment I according to the embodiment of the disclosure;

FIG. 4 is a schematic structural diagram of a product of Embodiment II according to the embodiment of this disclosure;

FIG. 5 is a product size measurement result of Embodiment II according to the embodiment of the disclosure.

### DESCRIPTION OF EMBODIMENTS

For better illustrating technical solutions of the present disclosure, embodiments of the present disclosure will be described in detail as follows with reference to the accompanying drawings.

It should be noted that, the described embodiments are merely exemplary embodiments of the present disclosure, which shall not be interpreted as providing limitations to the present disclosure. All other embodiments obtained by those skilled in the art without creative efforts according to the embodiments of the present disclosure are within the scope of the present disclosure.

The terms used in the embodiments of the present disclosure are merely for the purpose of describing particular embodiments but not intended to limit the present disclosure. Unless otherwise noted in the context, the singular form expressions “a”, “an”, “the” and “said” used in the embodiments and appended claims of the present disclosure are also intended to represent plural form expressions thereof.

It should be understood that the term “and/or” used herein is merely an association relationship describing associated objects, indicating that there may be three relationships, for example, A and/or B may indicate that three cases, i.e., A existing individually, A and B existing simultaneously, B existing individually. In addition, the character “/” herein generally indicates that the related objects before and after the character form an “or” relationship.

In the related art, with the continuous development of the shaping process, it is conceivable to form devices with high degrees of freedom by means of a simple forming process. Meanwhile, with the continuous development of technology, there are more requirements for miniaturization and lightness of ultrathin devices. There are mainly the following several manufacturing methods for forming ultrathin devices with high degrees of freedom. 1). A stamping process mainly applies pressure by means of a press machine, causing plastic deformation or separation to obtain a workpiece having a desired shape and size. 2). A powder metallurgy process mainly uses metal powder as raw material, and directly performs shaping process and sintering treatment on the powder raw material to form metal materials, composite materials and various types of products. 3). An injection shaping process mainly involves heating and plasticizing a material, and then injecting it into a mold cavity of a closed mold through a plunger or a reciprocating screw to form a product by a plastic processing method. However, in the above-mentioned several manufacturing methods, the stamping method cannot process materials with small thickness and poor ductility; and the ultrathin device formed by the powder metallurgy process has poor density, resulting in low strength of the ultrathin device and cannot meet the requirements. The ultrathin device formed by the injection shaping method has a high shrinkage rate, resulting in low product accuracy. Therefore, there is a need for a manufacturing method of an ultrathin device with high strength, good density, and high accuracy to meet the requirements of high strength, miniaturization, and lightness of a product.

In view of this, the embodiments of the present disclosure provide a manufacturing method for an ultrathin device, including the following steps.

At S100, a mixture containing a raw material powder, an adhesive and a solvent is granulated into particles by spray drying to obtain a first precursor, which has a surface mean diameter ranging from 40 μm to 80 μm, and flowability less than 30 s/50 g. The raw material powder includes metal material powder and/or ceramic material powder, and has a surface mean diameter ranging from 1 μm to 15 μm. A mass ratio of the raw material powder to the adhesive ranges from 100:1 to 100:10.

At S200, shaping process is performed on the first precursor is to obtain a second precursor with a preset shape.

At S300, heat treatment is performed on the second precursor to obtain an ultrathin device, which has a thickness less than or equal to 1 mm.

In the above-described solutions, a mixture containing the raw material powder, the adhesive and the solvent is granulated into particles by spray drying before the shaping process, and the raw material powder has a surface mean diameter ranging from 1 μm to 15 μm. In an aspect, good flowability of the material can be achieved; and in another aspect, the raw material powder has a small surface mean diameter, which is beneficial to increasing the density of the material when being mixed to form particles with an adhesive with a specific quality, to obtain a material having a small size. Compared with a conventional method in which the raw material powder is directly shaped, the first precursor according to the embodiments of the present disclosure has excellent flowability, which is lower than 30 s/50 g, making it beneficial for subsequent shaping processes, improving the flowability of the material in the shaping process, thereby improving the density and strength of ultrathin devices after the shaping process. Moreover, the first precursor with the surface mean diameter of 40 μm to 80 μm in this disclosure has a small particle diameter, which is conducive to improving the surface activity of the raw material powder. The powder in the particle-formed material is tightly combined and has a good compacted density. Then, the shaping process and heat treatment can improve the shaping performance of the shaping process and the sintering performance of the heat treatment, reduce the sintering temperature, and improve the density and the strength of the sintered ultrathin device. The first precursor before the shaping process according to the embodiments of the present disclosure has good flowability and small particle diameter. In the forming process, the thickness of the ultrathin device can be reduced without having a significant impact on the mechanical properties such as strength, rigidity, and toughness of the ultrathin device, thereby being conducive to improving the accuracy and miniaturization of the ultrathin device.

A manufacturing method of an ultrathin device will be described in the following in connection with the drawings in the present disclosure, and it is apparent that the embodiments described herein are merely some of, rather than all of the embodiments of the present disclosure. All other embodiments obtained by those skilled in the art based on the embodiments of the present disclosure without any creative effort shall fall within a protection scope of the present disclosure.

FIG. 1 is a flowchart of forming an ultrathin device according to an embodiment of the present disclosure. As shown in FIG. 1, the manufacturing method of the ultrathin device according to an embodiment of the present disclosure includes the following steps.

At S100: a mixture containing raw material powder, an adhesive and a solvent is granulated into particles by spray drying to obtain a first precursor. The raw material powder includes metal material powder and/or ceramic material powder, and has a surface mean diameter ranging from 1 μm to 15 μm. A mass ratio of the raw material powder to the adhesive ranges from 100:1 to 100:10. The first precursor has a surface particle diameter ranging from 40 μm to 80 μm, and flowability lower than 30 s/50 g.

For example, the first precursor is formed by the following steps.

At S101: a raw material powder, an adhesive and a solvent is mixed to obtain a slurry, i.e., a mixture.

In some embodiments, the raw material powder can be metal material powder, ceramic material powder, or a mixture of metal material powder and ceramic material powder. The metal material in the metal material powder includes at least one of elemental metal and alloy, and the elemental metal includes at least one of iron, cobalt, nickel, chromium, and manganese. The alloy includes at least one of iron alloy, copper alloy, nickel alloy, cobalt alloy, aluminum alloy, and titanium alloy. The ceramic material powder includes at least one of aluminum oxide powder, silicon oxide powder, zirconium oxide powder, silicon carbide powder, aluminum nitride powder and silicon nitride powder. The above-mentioned raw material powder has low ductility and high hardness, which can meet the requirements on physical properties and chemical properties of a small-sized ultrathin device of the present disclosure.

In some embodiments, the raw material powder has a surface mean diameter ranging from 1 μm to 15 μm, for example, 1 μm, 3 μm, 5 μm, 8 μm, 10 μm, 12 μm or 15 μm, etc., or any other value within the foregoing range, which will not be limited herein. In the embodiments of the present disclosure, superfine raw material powder is used for forming the part, so that the part has excellent characteristics such as high temperature resistance, high compactness, high strength and high rigidity.

In some embodiments, the particle diameter of the raw material powder satisfies: D90/D10≤7, for example, D90/D10 may be 1, 2, 3, 4, 5, 6, 7, or the like, or any other value within the foregoing range, which will not be limited herein. D90 refers to a particle diameter with a cumulative distribution of 90% raw material powder particles, D10 refers to a particle diameter with a cumulative distribution of 10% raw material powder particles. An ideal shaping processing raw material needs to have a narrow particle diameter distribution. Research has shown that ultrafine powder, due to its small size and high surface energy, is prone to self-aggregating between particles to form large particles, to reduce surface energy. Large particles have lower flowability and are prone to uneven distribution during the shaping process, resulting in uneven stress distribution in the formed ultrathin device. Therefore, the mechanical performance of the ultrathin device can be improved by narrowing the particle diameter distribution. The particle diameter of the raw material powder satisfies: D90/D10≤7. It indicates that the raw material powder has a relatively small particle diameter span, that is, the raw material powder has relatively uniform particle diameter distribution, so that the raw material powder can avoid the above problems and further has a relatively high bulk density, thereby improving the density and precision of forming the ultrathin device from the raw material powder.

The raw material powder in the present disclosure can be directly purchased through a commercially available way, or the raw material powder with a required particle diameter can be obtained by processing a raw material with a large particle diameter using mechanical grinding and other means.

In some embodiments, the adhesive includes a thermoplastic adhesive, including an olefinic polymer (polyvinyl acetate, polyvinyl alcohol, vinylidene chloride, polyisobutylene, etc.), polyester, polyether, polyamide, polyacrylate, and the like. For example, the thermoplastic adhesive can be at least one of polyvinyl alcohol, polyvinylpyrrolidone, polyethylene glycol. The adhesive has the characteristics of impact resistance, peeling strength and good initial adhesion, making it easy to use, and can be well combined with raw material powder. It is suitable for a subsequent granulation process.

In some embodiments, a mass ratio of the raw material powder to the adhesive ranges from 100:1 to 100:10, which can be 100:1, 100:2, 100:3, 100:5, 100:8 or 100:10, etc., or any other value within the foregoing range, which will not be limited herein. Within the above-described limited range, it can be ensured that the raw material powder in the mixture is combined together closely and has suitable flowability.

In some embodiments, the solvent includes water and alcohol solvent, which can be, for example, ethanol, propanol, pentanol, etc., which will not be limited herein.

At S102, the mixture is granulated into particles by spray drying to obtain a first precursor.

In the embodiments of the present disclosure, the slurry mixture with a certain solid phase content is atomized and granulated/formed to be particles by spray drying, which can avoid the reunion or sedimentation of the respective components in the slurry. Meanwhile, the slurry is uniformly atomized, and spherical particles with uniform particle diameter distribution and good flowability can be obtained. The spherical particles have a small angle of repose. And the first precursor can flow freely in the subsequent shaping process, which is beneficial for material shaping, and improving the distribution uniformity of the first precursor in the process of forming the ultrathin device.

In some embodiments, a device for spray drying includes at least one of a spray dryer, a centrifugal spray dryer, and a multi-nozzle spray dryer. Preferably, the device for spray drying is a centrifugal spray dryer.

In some embodiments, an inlet air temperature of the spray drying is within a range from 50° C. to 300° C., which can be, for example, 50° C., 80° C., 100° C., 200° C., 250° C. or 300° C., etc., or any other value within the foregoing range which will not be limited herein. If the inlet air temperature is higher than 300° C., it is easy for the liquid in the slurry to volatilize excessively and there is still a large amount of heat residue after the liquid volatilizes, easily causing the product to stick on the wall and cannot be received or product deterioration. If the inlet air temperature is less than 50° C., the product is in a semi-dry state, easily causing the parts to stick together to form aggregates.

In some embodiments, the outlet air temperature of the spray drying is within a range from 90° C. to 200° C., which can be, for example, 90° C., 100° C., 130° C., 150° C., 170° C., 180° C. or 200° C., or any other value within the foregoing range, which will not be limited herein. Within the foregoing range, the semi-dried or dried material in the device for spray drying can be heated, and the material can be shaped and dried using the residual temperature to reach a completely dry state, avoiding agglomeration of materials and being conducive to formation of spherical granular parts.

In some embodiments, the sphericity of the first precursor is greater than or equal to 0.7, such as 0.7, 0.8, 0.9, 1.0, or the like, or any other value within the foregoing range, which will not be limited herein. According to the embodiments of the present disclosure, the first precursor has a sphere-like shape, such a structure has good mixing uniformity and tight-bonding performance, thereby achieving excellent compactness and strength of the ultrathin device.

In some embodiments, the surface mean diameter of the first precursor is within a range from 40 μm to 80 μm, such as 40 μm, 45 μm, 50 μm, 55 μm, 60 μm, 70 μm or 80 μm, etc. Within the foregoing range, it indicates that the first precursor of the present disclosure has a small particle diameter of, that is, the raw material powder in the first precursor is tightly wrapped by the adhesive, with high density, which is beneficial for forming an ultrathin device with a small thickness and high strength; If the surface mean diameter of the first precursor is less than 40 μm, it indicates that there are much fine powder in the first precursor, which affects strength and rigidity of the device. If the surface mean diameter of the first precursor is greater than 80 μm, the material particles are large, making the shaping/processing process difficult, and physical particles are prone to crack or fragmentation during the shaping/processing process, resulting in a poor shaping effect. In the embodiments of the present disclosure, the surface mean diameter (SMD) refers to an average diameter of particles with a same volume and surface area ratio, which can be tested by a laser particle diameter tester to characterize the particle diameter uniformity of material particles in batches.

In some embodiments, the flowability of the first precursor is lower than 30 s/50 g, such as 5 s/50 g, 10 s/50 g, 15 s/50 g, 20 s/50 g, 25 s/50 g or 30 s/50 g, etc. It can be understood that the first precursor of the present disclosure is a granular structure. Within the foregoing range, it indicates that the first precursor has excellent flowability, so that the first precursor can be well filled into the mold for shaping process, which is beneficial to the stress uniformity of material distribution in the subsequent shaping process and improving the density of the semi-finished product after shaping. Meanwhile, the small flowability enables the shaped material after shaping process to have better smoothness and improve the precision of the ultrathin device. In the present disclosure, flowability refers to a time duration required for a certain amount of material particles to pass through a standard funnel with a specified pore size, and is usually used in a unit of s/50 g. The smaller the value is, the better the flowability of the powder is.

At S200, the first precursor is shaped to obtain a second precursor with a preset shape.

At this step, the first precursor can be loaded into a hopper of a shaping device, and conveyed into a mold cavity with a preset shape through a feeding pipe, then a shaped second precursor can be obtained by applying pressure. In this way, the utilization rate of the material is high, thereby improving the forming efficiency and reducing the forming cost.

In some embodiments, the preset shape of the mold cavity is the same as a shape of the finally-formed ultrathin device. That is, in the method according to the embodiments of present disclosure, the semi-finished product with a desired shape is formed while pressure applying. During the pressure applying process, the first precursor fully contact each other to form the semi-finished product, improving the compactness and sealing effect of the semi-finished product, thereby improving the mechanical strength of the semi-finished product.

In some embodiments, the mold cavity adopts mold steel according to a shape and a shaping requirement of the ultrathin device. The mold steel includes but is not limited to at least one of ASP23, ASP60, tungsten steel, SKD11, Cr12MoV, and DC53. In the mold steel made of the foregoing material, a shaping requirement of the second precursor can be achieved, and a semi-finished product with a certain strength in a preset shape can be formed.

In some embodiments, the device of the shaping process includes a servo press.

In some embodiments, a displacement precision of the shaping device is within a range from 1 μm to 3 μm, such as 1 μm, 1.5 μm, 2 μm, 2.5 μm, or 3 μm, etc., or any other value within the foregoing range, which will not be limited herein.

In some embodiments, the pressure of the shaping process is within a range from 300 MPa to 1200 MPa, such as 300 MPa, 500 MPa, 800 MPa, 1000 MPa, 1100 MPa, 1200 MPa, etc., or any other value within the foregoing range, which will not be limited herein.

In some embodiments, the shaping time duration is within a range from 2 s to 20 s, such as 2 s, 5 s, 8 s, 10 s, 13 s, 15 s, 18 s or 20 s, etc., or any other value within the foregoing range, which will not be limited herein.

In some embodiments, the shaping process can combine multiple stages of pressure and time duration, and the pressure and time duration used for each stage can be any value within the foregoing range, which will not be limited herein.

At S300, the second precursor is heat treated to obtain an ultrathin device.

At this step, the second precursor obtained at S200 is sintered after heat treatment, so that it has excellent mechanical properties when being solidified and molded.

In some embodiments, the temperature of the heat treatment is within a range from 1100° C. to 1500° C., such as 1100° C., 1150° C., 1200° C., 1250° C., 1300° C., 1350° C., 1400° C., 1450° C. or 1500° C., etc. Different heat treatment temperature ranges can be selected according to different raw material powders in the present disclosure, which will not be limited herein. The second precursor generates supramolecular acting force, interpenetrating effect and the like for consolidation in the heat treatment process, so that the strength, toughness and compactness of the ultrathin device are improved.

In some embodiments, a time duration of the heat treatment is within a range from 0.5 h to 5 h, such as 0.5 h, 1 h, 2 h, 3 h, 4 h or 5 h, etc., or any other value within the foregoing range, which will not be limited herein.

In some embodiments, a heating rate of the heat treatment is within a range from 1° C./min to 15° C./min, such as 1° C./min, 3° C./min, 5° C./min, 8° C./min, 10° C./min, 13° C./min or 15° C./min, etc., or any other value within the foregoing range, which will not be limited herein.

In some embodiments, the heat treatment is performed under a vacuum condition to prevent oxygen from entering into the second precursor to perform powder distribution oxidation, resulting in reduced purity of the ultrathin device and thus affecting the quality of the ultrathin device.

In some embodiments, the vacuum degree of the vacuum condition is less than or equal to 10⁻² Pa, such as 10⁻⁵, 10⁻⁴, 10⁻³ or 10⁻², etc., or any other value within the foregoing range, which will not be limited herein.

In some embodiments, the method further includes a step of post-processing the material obtained after the heat treatment, such as grinding and polishing and electroplating after the heat treatment, so as to improve the physical and mechanical properties of the ultrathin device.

The embodiments of the disclosure further provide the ultrathin device formed by the manufacturing method described above, the ultrathin device has a certain shape and a thickness smaller than or equal to 1 mm, which can effectively fill the blank in the application field of the powder metallurgy method for forming ultrathin devices.

The embodiments of the disclosure further provide a use of the ultrathin device in formation of device such as a motor, an engine, a loudspeaker, a receiver, a speaker, a microphone, a miniature vibration motor and an earphone, which is beneficial to improving the precision and lightness of the device.

The present disclosure is further described below with multiple embodiments. The implementations of the present disclosure are not limited to the embodiments described below. Various implementations can be made as appropriate within a scope of the independent claims.

### Embodiment I

1) 100 g of iron alloy powder, 20 g of polyethylene pyrrolidone, and 3 g of water are mixed and stirred to obtain a mixed slurry, a surface mean diameter of the iron alloy powder is within a range from 1 μm to 5 μm, and a particle diameter of the iron alloy satisfies: D90/D10≤7.

2) The mixed slurry obtained from step 1) is dried using a centrifugal spray dryer, with an inlet air temperature of 80° C. and an outlet air temperature of 100° C., to obtain a granular first precursor with a surface mean diameter ranging from 40 μm to 80 μm and flowability less than 30 s/50 g.

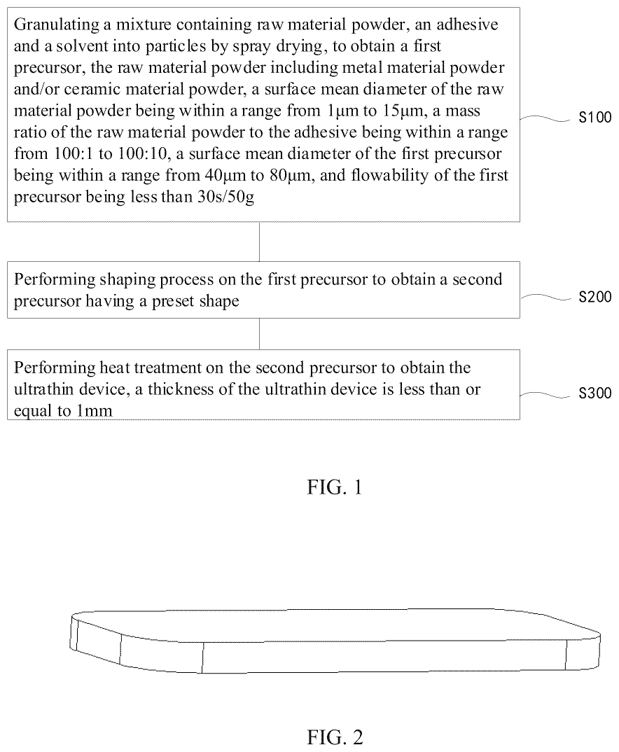

3) The first precursor obtained from step 2) is loaded into a hopper of a servo press, transported to a mold cavity through a feeding pipe, a shape of the mold cavity is shown in FIG. 2, with a pressure ranging from 300 MPa to 1200 MPa, a time duration ranging from 2 s to 20 s, and a precision of 2 μm, to obtain a second precursor.

4) The second precursor obtained from step 3) is fed to a vacuum sintering furnace for sintering treatment, with a sintering temperature of 1200° C. and a sintering time duration of 3 h, followed by grinding and polishing after the sintering treatment, to obtain an ultrathin device.

### Embodiment II

1) 100 g of iron alloy powder, 20 g of polyethylene pyrrolidone, and 3 g of water are mixed and stirred to obtain a mixed slurry, a surface mean diameter of the iron alloy powder is within a range from 1 μm to 5 μm, and a particle diameter of the iron alloy satisfies: D90/D10≤7.

2) The mixed slurry obtained from step 1) is dried using a centrifugal spray dryer, with an inlet air temperature of 80° C. and an outlet air temperature of 100° C., to obtain a granular first precursor with a surface mean diameter of ranging from 40 μm to 80 μm and flowability less than 30 s/50 g.

(3) The first precursor obtained from step 2) is loaded into a hopper of a servo press, transported to a mold cavity through a feeding pipe, a shape of the mold cavity is shown in FIG. 2, with a pressure ranging from 300 MPa to 1200 MPa, a time duration ranging from 2 s to 20 s, and a precision of 2 μm, to obtain a second precursor.

4) The second precursor obtained from step 3) is fed to a vacuum sintering furnace for sintering treatment, with a sintering temperature of 1200° C. and a sintering time duration of 3 h, followed by grinding and polishing after the sintering treatment, to obtain an ultrathin device.

20 different ultrathin devices are formed by selecting specific process parameters according to the formation process in Embodiment I of the present disclosure, and 10 different ultrathin devices are formed by selecting specific process parameters according to the formation process in Embodiment II. A thickness, a length, a width and flatness of each of the 30 different ultrathin devices are measured. The thickness, the length and the width are measured by a micrometer, and the flatness is measured by placing and fixing a target ultrathin device on a precision plane workbench, mounting a measurement part of a micrometer meter to make it contact a measurement surface, moving the target ultrathin device to evenly distribute the measurement positions, and reading the readings on the micrometer. A maximum value of the measured deviation denotes the flatness.

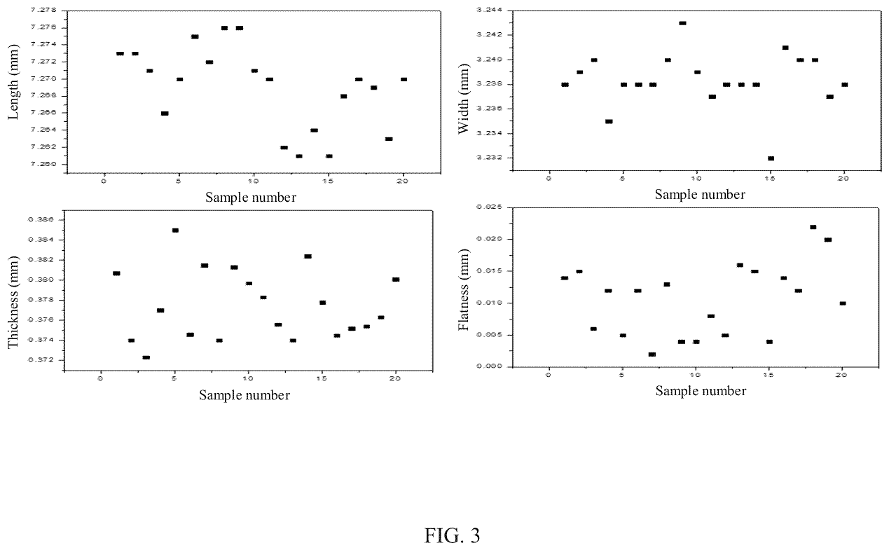

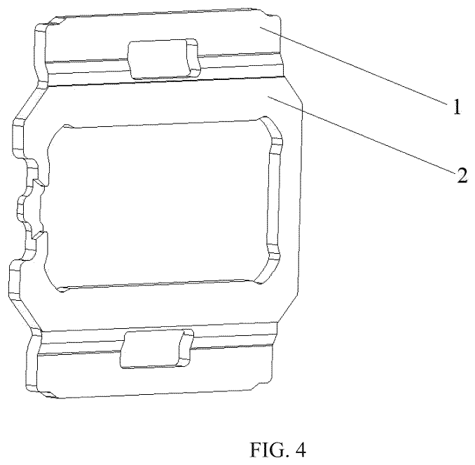

As shown in FIG. 3, the measurement result of the ultrathin devices formed according to Embodiment I can be seen from FIG. 3: The ultrathin devices formed according to Embodiment I of the present disclosure has a thickness ranging from 0.372 mm to 0.386 mm, flatness ranging 0 mm to 0.025 mm, and a relatively uniform numerical distribution, indicating that an ultrathin device with high accuracy and ultrathin performance can be formed according to the manufacturing method of the present disclosure.

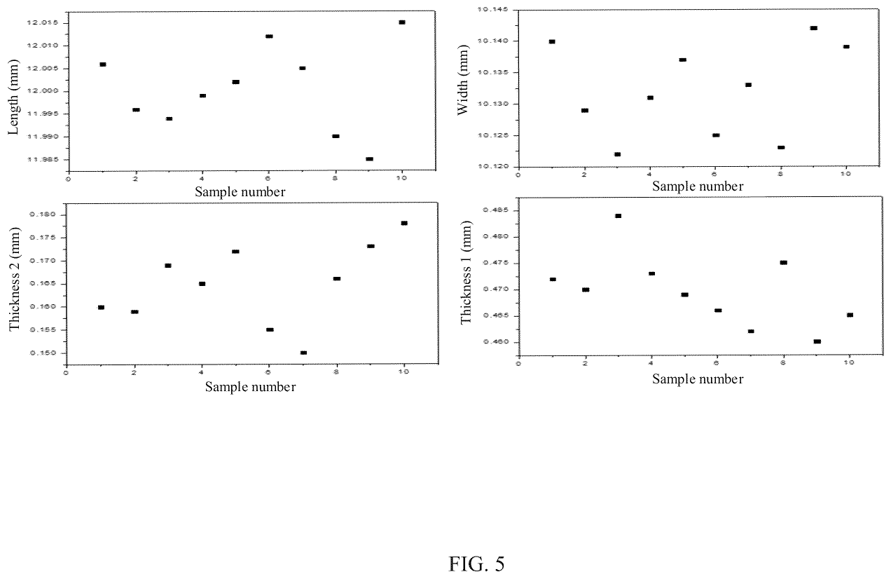

As shown in FIG. 5, the measurement result of the ultrathin devices formed according to Embodiment II can be seen from FIG. 5. Two different parts (a part 1 and a part 2) in FIG. 5 are selected for thickness measurement, the thickness of the part 1 ranges from 0.450 mm to 0.485 mm, and the thickness of the part 2 ranges from 0.150 mm to 0.180 mm. The numerical distribution is relatively uniform. It indicates that an ultrathin device with high accuracy and ultrathin performance can be formed according to the manufacturing method of the present disclosure.

The above-described embodiments are merely preferred embodiments of the present disclosure and are not intended to limit the present disclosure. Various changes and modifications can be made to the present disclosure by those skilled in the art. Any modifications, equivalent substitutions and improvements made within the principle of the present disclosure shall fall into the protection scope of the present disclosure.

Although the present disclosure is described above with reference to the preferred embodiments, but shall not be illustrated as being intended to limit the claims. Any of those skilled in the art can make several possible changes and modifications without departing from a concept of the present disclosure, so the protection scope of the present disclosure shall be defined by the claims of the present disclosure.

What is claimed is:

1. A manufacturing method for an ultrathin device, comprising:
granulating a mixture containing raw material powder, an adhesive and a solvent into particles by spray drying, to obtain a first precursor, wherein the raw material powder comprises metal material powder and/or ceramic material powder, a surface mean diameter of the raw material powder is within a range from 1 μm to 15 μm, a mass ratio of the raw material powder to the adhesive is within a range from 100:1 to 100:10, a surface mean diameter of the first precursor is within a range from 40 μm to 80 μm, and flowability of the first precursor is less than 30 s/50 g;
performing shaping process on the first precursor to obtain a second precursor having a preset shape; and
performing heat treatment on the second precursor to obtain the ultrathin device, wherein a thickness of the ultrathin device is less than or equal to 1 mm.

2. The manufacturing method as described in claim 1,
wherein a metal material in the metal material powder comprises at least one of elemental metal or alloy; and
wherein the elemental metal comprises at least one of iron, cobalt, nickel, chromium, or manganese; and the alloy comprises at least one of iron alloy, copper alloy, nickel alloy, cobalt alloy, aluminum alloy, or titanium alloy.

3. The manufacturing method as described in claim 1,
wherein the ceramic material powder comprises at least one of aluminum oxide powder, silicon oxide powder, zirconium oxide powder, silicon carbide powder, aluminum nitride powder, or silicon nitride powder.

4. The manufacturing method as described in claim 1,
wherein a particle diameter of the raw material powder satisfies: D90/D10≤7.

5. The manufacturing method as described in claim 1,
wherein the adhesive comprises a thermoplastic adhesive, and the adhesive comprises at least one of polyvinyl alcohol, polyvinylpyrrolidone, or polyethylene glycol.

6. The manufacturing method as described in claim 1,
wherein the solvent comprises at least one of water or ethanol.

7. The manufacturing method as described in claim 1,
wherein sphericity of the first precursor is greater than or equal to 0.7.

8. The manufacturing method as described in claim 1,
wherein an inlet air temperature of the spray drying is within a range from 50° C. to 300° C., and an outlet air temperature of the spray drying is within a range from 90° C. to 200° C.

9. The manufacturing method as described in claim 1,
wherein a device for spray drying comprises at least one of a spray dryer, a centrifugal spray dryer or a multi-nozzle spray dryer.

10. The method as described in claim 1,
wherein performing shaping process on the first precursor comprises: placing the first precursor in a shaping mold with a preset shape for pressure treatment.

11. The manufacturing method as described in claim 10,
wherein a device for the pressure treatment comprises a servo press with a displacement precision ranging from 1 μm to 3 μm.

12. The manufacturing method as described in claim 10,
wherein a pressure of the pressure treatment is within a range from 300 MPa to 1200 MPa, and a time duration of the pressure treatment is within a range from 2 s to 20 s.

13. The manufacturing method as described in claim 10,
wherein a material of the shaping mold comprises steel, which comprises at least one of ASP23, ASP60, tungsten steel, SKD11, Cr12MoV, or DC53.

14. The manufacturing method as described in claim 1,
wherein the heat treatment satisfies the following conditions:
the heat treatment has a temperature within a range from 1100° C. to 1500° C.;
the heat treatment has a time duration within a range from 0.5 h to 5 h;
the heat treatment has a heating rate within a range from 1° C./min to 15° C./min; and
the heat treatment is performed under a vacuum condition, and a vacuum degree of the vacuum condition is less than or equal to 10⁻² Pa.

15. An ultrathin device formed by the manufacturing method as described in claim 1,
wherein a thickness of the ultrathin device is less than or equal to 1 mm.

16. A use of the ultrathin device formed by the manufacturing method as described in claim 1 in forming a motor, an engine, a loudspeaker, a receiver, a speaker, a microphone, a miniature vibration motor and an earphone.
